(19) United States
(12) Patent Application Publication
(10) Pub. No.: US 2019/0094521 A1
(43) Pub. Date: Mar. 28, 2019

(54) ELECTROWETTING DEVICE AND METHOD FOR PRODUCING ELECTROWETTING DEVICE

(71) Applicant: SHARP KABUSHIKI KAISHA, Sakai City (JP)

(72) Inventors: CHIAKI MINARI, Sakai City (JP); TAKESHI HARA, Sakai City (JP); AKIHIKO SHIBATA, Yonago-shi (JP)

(21) Appl. No.: 16/141,872

(22) Filed: Sep. 25, 2018

(30) Foreign Application Priority Data
Sep. 26, 2017 (JP) 2017-185157

(51) Int. Cl. G02B 26/00

(52) U.S. Cl. CPC G02B 26/005

(57) ABSTRACT

The electrowetting device includes: an active substrate including a first substrate, a first electrode layer, a dielectric layer, and a first water-repellent layer; and a common electrode substrate including a second substrate, a second electrode layer, and a second water-repellent layer. The active substrate and the common electrode substrate are bonded together with a sealing material in sealing regions such that a space is formed between those substrates, and at least one of the dielectric layer and the second electrode layer has thereon (i) a water-repellent layer formation region in which the water-repellent layer is provided and (ii) a water-repellent-layer-free region. The sealing regions are provided so as to at least partially overlap with the water-repellent-layer-free region in a plan view, and the space has a size of 10 μm to 500 μm.

This Nonprovisional application claims priority under U.S.C. § 119 on Patent Application No. 2017-185157 filed in Japan on Sep. 26, 2017, the entire contents of which is hereby incorporated by reference.

### TECHNICAL FIELD

The present disclosure relates to an electrowetting device and a method for producing the electrowetting device.

### BACKGROUND ART

In the field of microfluidics and the like, manipulation of fluids on a small scale (e.g., sub-microliter) and precise control are required. Under the circumstances, attention is being given to electrowetting in which a droplet is manipulated by applying an electric field.

Electrowetting is a phenomenon in which, when a voltage is applied to a droplet placed on a dielectric layer which is provided on an electrode and has been subjected to hydrophobic treatment (i.e., water-repellent treatment), surface energy of the dielectric layer changes by electrostatic energy of a capacitor that is formed between the electrode and the droplet, and thus solid-fluid interface energy changes and accordingly a contact angle of the droplet with respect to a surface of the dielectric layer changes.

In recent years, development of an electrowetting device (also referred to as “microfluidic device” or “droplet device”) utilizing such electrowetting is being carried out.

For example, Patent Literature 1 discloses, as an example of an electrowetting device, an image display device which utilizes electrowetting.

In the image display device utilizing electrowetting, an electrically insulating hydrophobic film provided on a lower side substrate and an electrode layer provided on an upper side substrate are bonded together with a sealing material such that a space (cell gap) is provided between the electrically insulating hydrophobic film and the electrode layer, and thus a display panel is provided in which the electrically insulating hydrophobic film and the electrode layer face each other inside the display panel.

Meanwhile, as a technique to bond two substrates together with a sealing material, for example, Patent Literature 2 discloses a liquid crystal display device in which two substrates are bonded together with a sealing material while a liquid phase layer is provided between the two substrates. In Patent Literature 2, it is disclosed that a vertical alignment film and an ITO film which have different surface tensions with respect to the sealing material are provided on each of the substrates, and this improves linearity of the sealing material by preventing the sealing material from flowing out.

However, in the liquid crystal display device, liquid phase molecules are sealed in a space whose size is on the small order of several micrometers. The technique to bond substrates together so as to prevent the sealing material from flowing into such a thin space cannot be applied to an electrowetting device in which substrates are bonded together while securing, between the substrates, a space whose size is on the order of several tens to several hundreds of micrometers.

### CITATION LIST

### Patent Literature

[Patent Literature 1] Japanese Patent Application Publication, Tokukai, No. 2014-52561 (Publication Date: Mar. 20, 2014)

[Patent Literature 2] Japanese Patent Application Publication, Tokukai, No. 2008-52048 (Publication Date: Mar. 6, 2008)

### SUMMARY

### Technical Problem

In the electrowetting device, a water-repellent layer such as an electrically insulating hydrophobic film which is provided on a surface of the substrate is made of a particular material so as to bring about excellent water repellency for manipulating a droplet, and therefore material selectivity is limited. Accordingly, a process for forming the water-repellent layer is also limited. For example, a print-coating method or the like that is used to form an alignment film in a liquid crystal display device is difficult to apply to formation of a water-repellent layer in an electrowetting device. For forming a water-repellent layer, a coating method such as dip coating is currently employed in which a material is uniformly applied to a surface of a substrate.

However, in a case where a water-repellent layer is uniformly formed on a substrate as in the electrowetting device disclosed in Patent Literature 1, some problems may occur.

FIG. 7 is a view for explaining a problem of a conventional electrowetting device in which a water-repellent layer is uniformly formed on a substrate.

An electrowetting device 100V illustrated in FIG. 7 is made up of an active substrate including a first substrate 1, a common electrode substrate including a second substrate 8, and a sealing material 5 with which the active substrate and the common electrode substrate are bonded together.

The active substrate includes the first substrate 1, a thin film transistor formation layer 9 provided on the first substrate 1, a first electrode layer 2 which is provided on the thin film transistor formation layer 9 and is constituted by first electrodes which are electrically connected with respective drain electrodes of thin film transistors, a dielectric layer 3 provided so as to cover the first electrode layer 2, and a first water-repellent layer 4 which is uniformly provided on a surface of the dielectric layer 3 and has surface tension smaller than that of the dielectric layer 3.

Meanwhile, the common electrode substrate includes the second substrate 8, a second electrode layer 7 which is provided on the second substrate 8 and serves as a common electrode layer, and a second water-repellent layer which has surface tension smaller than that of the second electrode layer 7 and is uniformly provided on a surface of the second electrode layer 7.

In the conventional electrowetting device 100V, the first water-repellent layer 4 and the second water-repellent layer 6 repel the sealing material 5, and therefore sufficient adherence cannot be obtained, and a defect in sealing is more likely to occur. Moreover, a problem may occur in which a reagent such as an oil sealed in the space leaks out.

An aspect of the present disclosure is accomplished in view of the problems, and its object is to provide an electrowetting device which has excellent adherence between two substrates.

### Solution to Problem

In order to attain the object, an electrowetting device in accordance with an aspect of the present disclosure includes: an active substrate including a first substrate, a first electrode layer provided on the first substrate, dielectric layer provided so as to cover the first electrode layer, and a first water-repellent layer which has surface tension smaller than that of the dielectric layer and is provided on the dielectric layer; and a common electrode substrate including a second substrate, a second electrode layer provided on the second substrate, and a second water-repellent layer which has surface tension smaller than that of the second electrode layer and is provided on the second electrode layer, the active substrate and the common electrode substrate being bonded together with a sealing material such that a space is formed between the active substrate and the common electrode substrate and the first water-repellent layer and the second water-repellent layer face each other, the sealing material being provided in sealing regions, at least one of the dielectric layer and the second electrode layer having thereon (i) a water-repellent layer formation region in which the water-repellent layer is provided and (ii) a water-repellent-layer-free region, the sealing regions being provided so as to at least partially overlap with the water-repellent-layer-free region in a plan view, and the space having a size of 10 μm to 500 μm.

### Advantageous Effects of Invention

According to an aspect of the present disclosure, it is possible to provide the electrowetting device which has excellent adherence between two substrates.

### BRIEF DESCRIPTION OF DRAWINGS

FIG. 1 is a partial cross-sectional view schematically illustrating a configuration of an electrowetting device in accordance with Embodiment 1.

FIG. 2 is a view illustrating some steps in an example method for producing the electrowetting device.

FIG. 3 is a view illustrating some steps in another example method for producing the electrowetting device.

FIG. 4 is a partial cross-sectional view schematically illustrating a configuration of an electrowetting device in accordance with Embodiment 2.

FIG. 5 is a partial cross-sectional view schematically illustrating a configuration of an electrowetting device in accordance with Embodiment 3.

FIG. 6 is a partial cross-sectional view in a case where a droplet 22 is fed into the electrowetting device, and illustrates a shape of the droplet 22, a space d, a contact angle θ of the droplet with respect to a surface of a water-repellent layer, θ′ which represents (θ−90°)×1/2, and a shortest distance a from an inner circumferential edge of a sealing region to an inner circumferential edge of a water-repellent-layer-free region.

FIG. 7 is a view for explaining a problem of a conventional electrowetting device in which a water-repellent layer is uniformly formed on a substrate.

### DESCRIPTION OF EMBODIMENTS

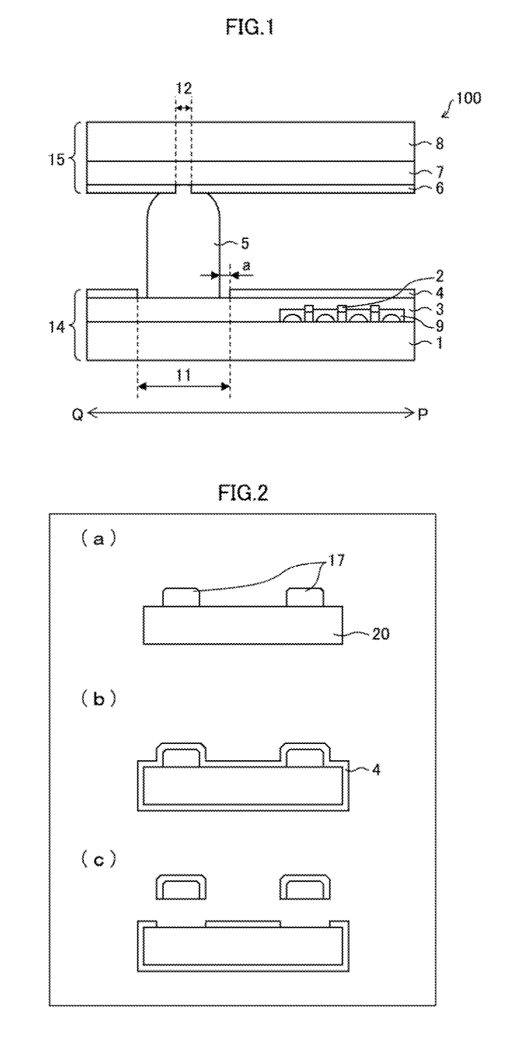

The following description will discuss embodiments of the present disclosure with reference to FIGS. 1 through 6. Hereinafter, for convenience of explanation, the same reference numerals are given to constituent members which have functions identical with those described in a particular embodiment, and descriptions regarding such constituent members may be omitted.

### Embodiment 1

In Embodiment 1, an active matrix electrowetting-on-dielectric (AM-EWOD) device will be described as an electrowetting device, in which droplet driving (electrowetting-on-dielectric; EWOD) is carried out in an active matrix arrangement of thin film transistors (TFT).

FIG. 1 is a partial cross-sectional view schematically illustrating a configuration of an AM-EWOD device 100 in accordance with Embodiment 1.

As illustrated in FIG. 1, the AM-EWOD device 100 in accordance with Embodiment 1 is made up of an active substrate 14 including a first substrate a common electrode substrate 15 including a second substrate 8, and a sealing material 5 with which the active substrate 14 and the common electrode substrate 15 are bonded together. Here, the sealing material 5 is provided with a predetermined width in a whole circumference part of facing surfaces of the both substrates which are bonded together. In this arrangement, further, the sealing material 5 is provided so as to seal a space between the active substrate 14 and the common electrode substrate 15 for each cell (AM-EWOD device).

The active substrate 14 includes the first substrate 1, a thin film transistor formation layer 9 provided on the first substrate 1, a first electrode layer 2 which is provided on the thin film transistor formation layer 9 and is constituted by first electrodes which are electrically connected with respective drain electrodes of thin film transistors, a dielectric layer 3 provided so as to cover the first electrode layer 2, and a first water-repellent layer 4 which is provided on the dielectric layer 3 and has surface tension smaller than that of the dielectric layer 3.

The dielectric layer 3 has a first water-repellent layer formation region and a first water-repellent-layer-free region 11. The first water-repellent layer formation region is a part of a surface region of the dielectric layer 3 on which part the first water-repellent layer 4 is stacked. Meanwhile, the first water-repellent-layer-free region 11 can be a part of the surface region of the dielectric layer 3 in which part the water-repellent layer is not stacked or can be an opening region from which the stacked water-repellent layer has been removed. Alternatively, the first water-repellent-layer-free region 11 can be a region which is obtained by subjecting a part of the water-repellent layer to surface modification by local surface treatment and thus has reduced water repellency.

Meanwhile, the common electrode substrate 15 includes a second substrate 8, a second electrode layer 7 which is provided on the second substrate 8 and serves as a common electrode layer, and a second water-repellent layer 6 which has surface tension smaller than that of the second electrode layer 7 and is provided on the second electrode layer 7.

The second electrode layer 7 has a second water-repellent layer formation region and a second water-repellent-layer-free region 12. The second water-repellent layer formation region is a part of a surface region of the second electrode layer 7 on which part the second water-repellent layer 6 is stacked. Meanwhile, the second water-repellent-layer-free region 12 can be a part of the surface region of the second electrode layer 7 in which part the water-repellent layer is not stacked or can be an opening region from which the stacked water-repellent layer has been removed. Alternatively, the second water-repellent-layer-free region 12 can be a region which is obtained by subjecting a part of the water-repellent layer to surface modification by local surface treatment and thus has reduced water repellency.

Both of the first water-repellent-layer-free region 11 and the second water-repellent-layer-free region 12 can be opening regions of the water-repellent layers. Alternatively, both of the first water-repellent-layer-free region 11 and the second water-repellent-layer-free region 12 can be regions each of which is obtained by subjecting a part of the water-repellent layer to surface modification by local surface treatment. Alternatively, it is possible that one of the first water-repellent-layer-free region 11 and the second water-repellent-layer-free region 12 is an opening region of the water-repellent layer, and the other is a region subjected to surface modification.

Among a space between the active substrate 14 and the common electrode substrate 15, one or more droplets and a reagent such as an oil as a nonconductive liquid (which are not illustrated) are enclosed in a space which is on a substrate inner side P and is sealed with the sealing material 5.

The common electrode substrate 15 can be provided with through holes (not illustrated) which serve as one or more inlets through which a reagent is fed into the space and as one or more outlets through which a gas in the space is discharged. Alternatively, the inlet and the outlet can be formed by providing openings in the sealing material 5. In this case, it is possible to laterally feed the reagent into the AM-EWOD device.

The droplet which has been fed through the inlet into the space on the substrate inner side P moves on the water-repellent layer along the space serving as a flow channel.

The first substrate 1 which constitutes the active substrate 14 can be, for example, a glass substrate.

Each of the first electrodes which constitute the first electrode layer 2 is an active matrix (AM) electrode and can be, for example, a transparent oxide electrode made of a material such as indium tin oxide (ITO), indium zinc oxide (IZO), or zinc oxide (ZnO), or a metallic electrode made of a material such as titanium (Ti) or aluminum (Al). The first electrodes are arranged on the thin film transistor formation layer 9 in an array of M×N (where each of M and N is an arbitrary number).

The dielectric layer 3 is provided on the thin film transistor formation layer 9 and the first electrode layer 2 so as to cover the plurality of first electrodes, and separates the first electrode layer 2 from the first water-repellent layer 4. The dielectric layer 3 can be made of silicon oxide, silicon nitride, silicon oxynitride, aluminum oxide, or the like, and can be formed by using plasma chemical vapor deposition (CVD), atomic layer deposition (ALD), or the like.

The first water-repellent layer 4 is obtained by applying a solution (diluted solution) containing a water-repellent material by a commonly used method such as dip coating, spray coating, spin coating, bar coating, or print coating, and forming the solution into a film.

Alternatively, the first water-repellent layer 4 can be formed, with use of a target or a source gas from which a water-repellent film can be formed, as a thin film on the dielectric layer by a commonly used method for forming a thin film, for example, physical vapor deposition (PVD) such as sputtering or chemical vapor deposition (CVD) such as plasma CVD.

As the water-repellent material, a fluorocarbon resin having high water repellency can be used. Such a fluorocarbon resin can be CYTOP (Registered Trademark) which is a perfluoroamorphous resin manufactured by AGC Asahi Glass Co., Ltd., DURASURF (Registered Trademark) manufactured by Harves Co., Ltd., OPTOOL (Registered Trademark) manufactured by Daikin industries, Ltd., or the like.

The first water-repellent-layer-free region 11 of the dielectric layer 3 can be formed by, for example, lifting off, masking, or the like. As illustrated in (a) of FIG. 2, a resist 17 is provided, by patterning or masking, on a lower side substrate 20 in which a dielectric layer is provided on a first substrate. In this case, the resist 17 is formed with screen printing, gravure printing, or the like. Next, as illustrated in (b) of FIG. 2, a water-repellent layer 4 is laminated by dip coating, or the like. Next, as illustrated in of FIG. 2, the resist 17 or a mask is removed, and thus the first water-repellent-layer-free region 11 can be formed which is as an opening region of the water-repellent layer.

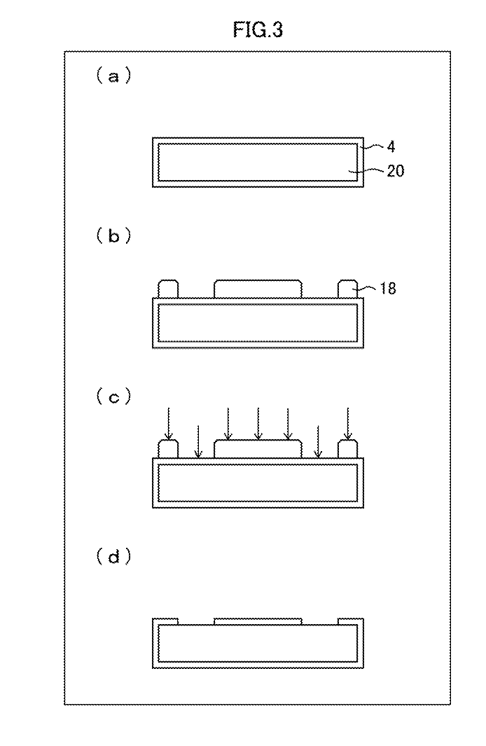

Alternatively, the first water-repellent-layer-free region 11 can be formed by locally removing the water-repellent layer 4 which has been laminated on the entire dielectric layer by dip coating or the like. As illustrated in (a) of FIG. 3, a water-repellent layer 4 is laminated on an entire lower side substrate 20 in which a dielectric layer is provided on a first substrate. Next, as illustrated in (b) of FIG. 3, a dry etching mask 18 is provided by patterning with use of a lithography technique such as photolithography. Next, as illustrated in (c) of FIG. 3, the water-repellent layer is locally removed by dry etching. Next, as illustrated in (d) of FIG. 3, the dry etching mask 18 is removed by wet etching, and thus the first water-repellent-layer-free region 11 can be formed which is as an opening region of the water-repellent layer. The means for locally removing the water-repellent layer is riot limited to dry etching, and it is possible to employ removing by a laser, or a blasting process using sandblast, dry ice snow, or the like. Alternatively, the water-repellent layer can be locally removed by a combination of a drawing system and machining, etc. The water-repellent layer can be completely removed until its base layer, i.e., the dielectric layer is exposed. Alternatively, the water-repellent layer can be partially removed to an extent that water repellency is decreased and adherence with the sealing material 5 (described later) is enhanced. For example, the first water-repellent-layer-free region 11 can be formed by lowering water repellency of the water-repellent layer which has been laminated on the entire dielectric layer. In this case, the water repellency is lowered by locally carrying out surface treatment such as plasma treatment or ultraviolet irradiation with respect to a surface of the water-repellent layer.

The second substrate 8 constituting the common electrode substrate 15 can be, for example, a glass substrate, as with the foregoing first substrate 1.

Each of second electrodes which constitute the second electrode layer 7 is, for example, a transparent oxide electrode made of a material such as ITO, IZO, or ZnO, or a metallic electrode made of a material such as titanium (Ti) or aluminum (Al).

The second water-repellent layer 6 can be formed with use of a water-repellent material similar to that of the first water-repellent layer 4 by a film formation method similar to that for the first water-repellent layer 4.

The second water-repellent-layer-free region 12 of the second electrode layer 7 can be formed by a method similar to that for the first water-repellent-layer-free region 11.

As the droplet, an electroconductive liquid such as an ionic liquid or a polar liquid is used, and it is possible to use, for example, a liquid such as water, an electrolytic solution (which is an aqueous solution of electrolyte), alcohols, or various kinds of ionic liquids. Examples of the droplet encompass a whole blood sample, a bacterial cell suspension, a solution of protein or antibody, various buffer solutions, and the like.

Into the flow channel through which the droplet moves, an oil can be fed as a nonconductive liquid which is immiscible with the droplet. For example, in the flow channel, a volume which is not occupied by the droplet may be filled with the oil.

Note that the nonconductive liquid can be a nonpolar liquid (nonionic liquid) having surface tension smaller than that of the droplet. Examples of the nonconductive liquid encompass hydrocarbon-based solvents (low-molecular-hydrocarbon-based solvents) such as decane, dodecane, hexadecane, and undecane, oils such as silicone oil, and fluorocarbon-based solvents. The silicone oil can be dimethylpolysiloxane, or the like. Note that it is possible to use only one kind of nonconductive liquid, or it is possible to use a mixture of some kinds of nonconductive liquids as appropriate.

The active substrate 14 and the common electrode substrate 15 are bonded together with the sealing material 5, which has been provided in sealing regions with use of a dispenser, such that a space is formed between the active substrate 14 and the common electrode substrate 15 and the first water-repellent layer 4 and the second water-repellent layer 6 face each other. Here, the “sealing regions” indicate regions in which the sealing material makes contact with the active substrate 14 and the common electrode substrate 15.

In a case where the active substrate 14 and the common electrode substrate 15 are bonded together, first, the sealing material 5 is provided on the sealing region of one of those substrates with use of a dispenser. The sealing material 5 is arranged along a whole circumference of an outer edge of a cell (AM-EWOD device) which is to be divided in a subsequent process. Next, the sealing material 5 is aligned with and bonded to the sealing region of the other substrate.

In this case, in order to secure a space (cell gap) between the active substrate and the common electrode substrate, spacer beads such as plastic beads or glass beads are added to the sealing material 5 if needed. A thickness of the space, that is, a distance between those substrates is, for example, 10 μm to 500 μm, preferably 60 μm to 430 μm, more preferably 110 μm to 380 μm, further preferably 210 μm to 270 μm. In Embodiment 1, the thickness of the space is 250 μm. In a case where the thickness of the space falls within the above range, it is possible to carry out good manipulation of a droplet in the electrowetting device by feeding a predetermined amount of a reagent into the cell.

After the substrates are bonded together, the sealing material 5 is hardened by carrying out annealing treatment while applying predetermined force to both the substrates. As such, it is possible to bond the active substrate and the common electrode substrate together while securing a uniform cell gap. The sealing material 5 is provided with a predetermined width in a whole circumference of the outer edge of the cell so as to seal the space between the active substrate and the common electrode substrate for each cell.

In the AM-EWOD device 100 in accordance with Embodiment 1, each of the first water-repellent-layer-free region 11 and the second water-repellent-layer-free region is provided with a predetermined width in a whole circumference part of a corresponding one of facing surfaces of the substrates, as with the sealing region that is provided with the predetermined width in the whole circumference part. Each of the water-repellent-layer-free regions and the sealing region overlap with each other by a predetermined width in the whole circumference part. Note that it is possible to provide only one of the first and second water-repellent-layer-free regions.

In the water-repellent-layer-free region, a base layer (i.e., the dielectric layer or the second electrode layer having surface tension greater than that of the water-repellent layer is exposed, or water repellency of the water-repellent layer is lowered and surface tension of the water-repellent layer is enhanced. That is, a contact angle between the sealing material 5 and the water-repellent-layer-free region is smaller than a contact angle between the sealing material 5 and the first water-repellent layer 4 or the second water-repellent layer 6.

Therefore, in a part in which the water-repellent-layer-free region and the sealing region overlap with each other, the sealing material firmly adheres to each of the substrates, and thus sufficient sealing strength can be obtained. From this, it is possible to produce the AM-EWOD device having excellent adherence between the substrates, and this makes it possible to prevent a problem of leakage of a fluid that is sealed in the space. Note that the width of the water-repellent-layer-free region indicates a shortest distance between a point on an outer circumferential edge of the water-repellent-layer-free region that is provided in the whole circumference of the outer edge of the cell (that is, an end part on a substrate outer side Q) to an inner circumferential edge (that is, an end part on the substrate inner side P (i.e., a flow channel side)) of the water-repellent-layer-free region.

In the AM-EWOD device 100 in accordance with Embodiment 1, as illustrated in FIG. 1, the sealing region in which the sealing material 5 makes contact with the active substrate 14 is located in the first water-repellent-layer-free region 11 of the active substrate 14, and does not extend over a boundary between the water-repellent layer formation region and the water-repellent-layer-free region 11 on the dielectric layer 3. Meanwhile, the sealing region in which the sealing material 5 makes contact with the common electrode substrate 15 is provided so as to extend over a boundary between the water-repellent layer formation region and the water-repellent-layer-free region 12, that is, so as to cover the second water-repellent-layer-free region 12 of the common electrode substrate 15.

The positional relation between the sealing region and the water-repellent-layer-free region is riot limited to the above described arrangement, and the sealing region can be provided so as to extend over all boundaries between the water-repellent layer formation regions and the water-repellent-layer-free regions, that is, so as to cover both the water-repellent-layer-free regions. Alternatively, the sealing region can be provided in both the water-repellent-layer-free regions so as not to extend over all boundaries between the water-repellent layer formation regions and the water-repellent-layer-free regions. Alternatively, the sealing region can be provided so as to partially overlap with the water-repellent-layer-free region, that is, so as to extend over a part of boundary between the water-repellent layer formation region and the water-repellent-layer-free region but not to extend over the rest of the boundary.

A width of the part in which the sealing region overlaps with each of the first and second water-repellent-layer-free regions is not limited to a particular width, provided that adhesion force between the sealing material and each of the substrates can be secured. Note, however, that, in order to achieve sufficiently high adhesion force, a smallest width of the overlapping part is preferably 0.5 mm or more, more preferably 1.0 mm or more, further preferably 1.5 mm or more.

A width of the sealing region is not limited to a particular width, provided that the overlapping part with the water-repellent-layer-free region has a sufficient width and a sufficient region for manipulating a droplet in the cell can be secured.

A width of each of the water-repellent-layer-free regions is not limited to a particular width, provided that the overlapping part with the sealing region has a sufficient width and a sufficient region for manipulating a droplet in the cell can be secured.

In particular, as seen in the positional relation between the first water-repellent-layer-free region 11 and the sealing region in FIG. 1, in a case where the inner circumferential edge of the sealing region is located in the water-repellent-layer-free region and a shortest distance a from the inner circumferential edge of the sealing region to the inner circumferential edge of the water-repellent-layer-free region is excessively large, the region for manipulating a droplet in the cell is narrowed, and such an arrangement is not preferable. That is, the region for manipulating a droplet is provided on the water-repellent layer, and therefore the shortest distance a is preferably smaller in order to maximally secure the region for manipulating a droplet in the cell. In a case where a droplet makes contact with the water-repellent-layer-free region having greater surface tension, it is difficult for the droplet to move onto the water-repellent layer having smaller surface tension.

Meanwhile, in order to prevent the droplet from making contact with a lateral wall of the sealing material 5, strictly, the region for manipulating a droplet does not abut on the sealing region, and a small gap exists between those regions. Therefore, even in a case where the water-repellent-layer-free region lies toward the substrate inner side by a predetermined width a from the inner circumferential edge of the sealing region, the water-repellent-layer-free region does not affect the region for manipulating a droplet, as long as the width a is smaller than a width of the gap.

That is, the shortest distance a from the inner circumferential edge of the sealing region to the inner circumferential edge of the water-repellent-layer-free region is preferably smaller than the width of the gap between the region for manipulating a droplet and the sealing region.

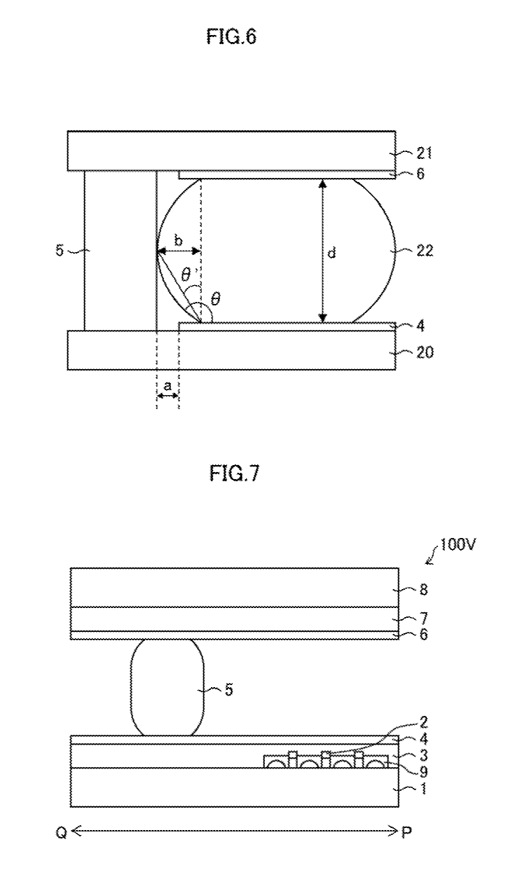

The following description will discuss this point with reference to FIG. 6.

FIG. 6 is a partial cross-sectional view in a case where a droplet 22 is fed into the electrowetting device, and illustrates a shape of the droplet 22, a cell gap d, contact angle θ of the droplet with respect to a surface of a water-repellent layer, θ′ which represents (θ−90°)×1/2, and a shortest distance a from an inner circumferential edge of a sealing region to an inner circumferential edge of a water-repellent-layer-free region.

For convenience of explanation, FIG. 6 illustrates a simplified layer configuration inside the substrate, and the first substrate 1, the first electrode layer 2, the dielectric layer 3, and the thin film transistor formation layer 9 are correctively shown as the lower side substrate 20. Similarly, the second substrate 8 and the second electrode layer 7 are correctively illustrated as an upper side substrate 21.

In each of the lower side substrate 20 and the upper side substrate 21 in FIG. 6, the water-repellent-layer-free region lies on the substrate inner side.

The droplet 22 in the cell has a shape as illustrated in FIG. 6, and the droplet 22 can move in a region in which the first water-repellent layer 4 and the second water-repellent layer 6 are provided. However, strictly, a small gap exists between the region for manipulating a droplet and the sealing region so that the droplet 22 does not make contact with the lateral wall of the sealing material 5.

A width b of the gap is approximated by the following formula (1) with use of a cell gap d and a contact angle θ of the droplet with respect to a surface of the water-repellent layer.

$$\begin{matrix}[ Math . 1 ] & \\ b = \frac{d}{2} tan ( \frac{θ - 90 °}{2} ) & ( 1 )\end{matrix}$$

In the formula (1), d represents the cell gap, and θ represents the contact angle of the droplet with respect to a surface of the water-repellent layer.

From this, a preferable range of the shortest distance a from the inner circumferential edge of the sealing region to the inner circumferential edge of the water-repellent-layer-free region is represented by the following formula (2).

$$\begin{matrix}[ Math . 2 ] & \\ a < \frac{d}{2} tan ( \frac{θ - 90 °}{2} ) & ( 2 )\end{matrix}$$

In a case where the shortest distance a from the inner circumferential edge of the sealing region to the inner circumferential edge of the water-repellent-layer-free region falls within the range represented by the formula (2), it is possible to maximally secure the region for manipulating a droplet in the cell without substantial influence caused by the shortest distance a on the region for manipulating a droplet.

The cell gap d in the electrowetting device is, for example, 10 μm to 500 μm, preferably 60 μm to 430 μm, more preferably 110 μm to 380 μm, further preferably 210 μm to 270 μm. Meanwhile, the pseudo contact angle θ of the droplet provided between the upper and lower substrates each of which has the water-repellent layer as illustrated in FIG. 6 is, for example, 100° to 160°, preferably 115° to 155°, more preferably 130° to 150°. Therefore, in view of the width b of the gap which is obtained based on the combination of the cell gap d and the contact angle θ, the shortest distance a in the whole circumference part of each of the facing surfaces of the substrates is, for example, preferably 150 μm or less, more preferably 100 μm or less, further preferably 50 μm or less.

Meanwhile, as seen in the positional relation between the second water-repellent-layer-free region 12 and the sealing region in FIG. 1, in a case where the inner circumferential edge of the sealing region is located outside of the water-repellent-layer-free region and an overlapping width from the inner circumferential edge of the sealing region to the inner circumferential edge of the water-repellent-layer-free region is excessively large, the region for manipulating a droplet in the cell is narrowed, and such an arrangement is not preferable. Therefore, the shortest distance from the inner circumferential edge of the sealing region to the inner circumferential edge of the water-repellent-layer-free region (i.e., the overlapping width) in the whole circumference part of each of the facing surfaces of the substrates is, for example, preferably 150 μm or less, more preferably 100 μm or less, further preferably 50 μm or less.

According to Embodiment 1, firm adhesion between the sealing material and each of the substrates can be obtained in the part in which the sealing region and the water-repellent-layer-free region overlap with each other, and it is therefore possible to prevent a problem of leakage of a fluid that is sealed in the space.

In the electrowetting device, the cell gap is large, and therefore a larger amount of the sealing material is used, as compared with the liquid crystal display device. From this, the sealing region in which the sealing material is to be provided is more likely to be misaligned. However, according to Embodiment 1, it is only necessary that each of the first water-repellent-layer-free region and the second water-repellent-layer-free region at least partially overlaps with the sealing region, and it is possible to secure high adherence between each of the substrates and the sealing material without carrying out precise alignment for matching those regions.

Further, for a reason similar to that described above, according to Embodiment 1, the water-repellent-layer-free region can be formed with some margin of error. From this, for forming the water-repellent-layer-free region, it is possible to use a method other than photolithography that enables relatively precise alignment. For example, in Embodiment 1, the water-repellent-layer-free region can be formed with use of simpler means such as a laser, sandblast, or dry ice snow, or by simpler surface treatment such as local plasma treatment or ultraviolet irradiation.

### Embodiment 2

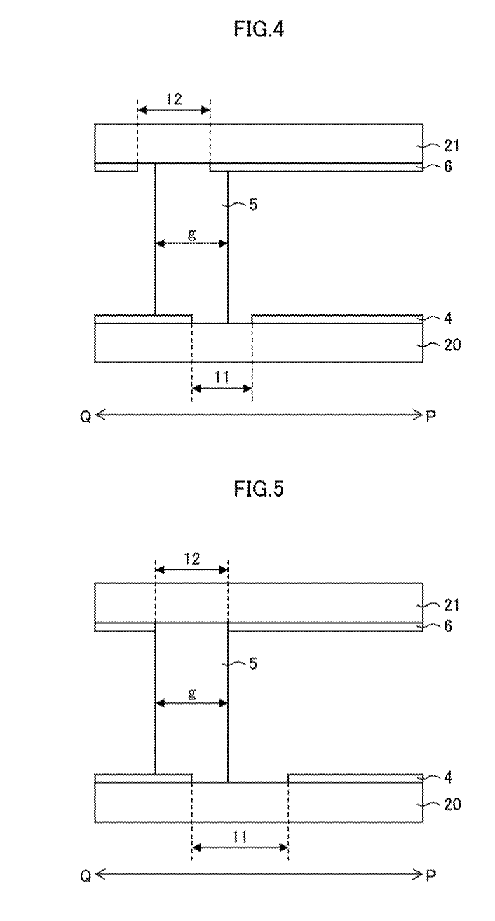

The following description will discuss Embodiment 2 of the present disclosure with reference to FIG. 4.

In Embodiment 2, a positional relation between a sealing region g and each of a first water-repellent-layer-free region 11 and a second water-repellent-layer-free region 12 is different from that of Embodiment 1, and the other configurations are identical with those described in Embodiment 1.

For convenience of explanation, FIG. 4 illustrates a simplified layer configuration inside a substrate, and a first substrate 1, a first electrode layer 2, a dielectric layer 3, and a thin film transistor formation layer 9 are correctively shown as a lower side substrate 20. Similarly, a second substrate 8 and a second electrode layer 7 are correctively illustrated as an upper side substrate 21. Moreover, the same reference numerals as in FIG. 1 of Embodiment 1 are given to a first water-repellent layer 4, a sealing material 5, a second water-repellent layer 6, a first water-repellent-layer-free region 11, and a second water-repellent-layer-free region 12. Those constituent members and regions have configurations identical with those in Embodiment 1, and therefore are not repeatedly described.

In Embodiment 2, as illustrated in FIG. 4, the sealing region g in which the sealing material 5 makes contact with the lower side substrate 20 (i) does not extend over a part of a boundary, which part is on the substrate inner side P, between the first water-repellent layer formation region and the first water-repellent-layer-free region 11 in the lower side substrate, (ii) extends over a part of the boundary which part is located on the substrate outer side Q, and (iii) partially overlaps with the first water-repellent-layer-free region 11.

Meanwhile, the sealing region g in which the sealing material 5 makes contact with the upper side substrate 21 (i) does not extend over a part of a boundary, which part is on the substrate outer side Q, between the second water-repellent layer formation region and the second water-repellent-layer-free region 12 in the upper side substrate, (ii) extends over a part of the boundary which part is located on the substrate inner side P, and (iii) partially overlaps with the second water-repellent-layer-free region 12.

According to Embodiment 2, it is only necessary that each of the first water-repellent-layer-free region 11 of the lower side substrate 20 and the second water-repellent-layer-free region 12 of the upper side substrate 21 partially overlaps with the sealing region g, and the first water-repellent-layer-free region 11 and the second water-repellent-layer-free region 12 may or may not overlap with each other in the plan view. Therefore, in the step of bonding the substrates together, it is not necessary to carry out strict alignment, and it is possible to bond the substrates together with high sealing strength.

### Embodiment 3

The following description will discuss Embodiment 3 of the present disclosure with reference to FIG. 5.

In Embodiment 3, a positional relation between a sealing region g and each of a first water-repellent-layer-free region 11 and a second water-repellent-layer-free region 12 is different from that of Embodiment 1, and the other configurations are identical with those described in Embodiment 1.

For convenience of explanation, FIG. 5 illustrates a simplified layer configuration inside a substrate, and a first substrate 1, a first electrode layer 2, a dielectric layer 3, and a thin film transistor formation layer 9 are correctively shown as a lower side substrate 20. Similarly, a second substrate 8 and a second electrode layer 7 are correctively illustrated as an upper side substrate 21. Moreover, the same reference numerals as in FIG. 1 of Embodiment 1 are given to a first water-repellent layer 4, a sealing material 5, a second water-repellent layer 6, a first water-repellent-layer-free region 11, and a second water-repellent-layer-free region 12. Those constituent members and regions have configurations identical with those in Embodiment 1, and therefore are not repeatedly described.

In Embodiment 3, as illustrated in FIG. 5, the sealing region g in which the sealing material 5 makes contact with the lower side substrate 20 (i) does not extend over a part of a boundary, which part is on the substrate inner side P, between the first water-repellent layer formation region and the first water-repellent-layer-free region 11 in the lower side substrate, (ii) extends over a part of the boundary which part is located on the substrate outer side Q, and (iii) partially overlaps with the first water-repellent-layer-free region 11.

Meanwhile, the sealing region g in which the sealing material 5 makes contact with the upper side substrate 21 matches the second water-repellent-layer-free region 12 of the upper side substrate.

The electrowetting device in accordance with Embodiment 3 can be suitably produced by, for example, providing the sealing material 5 on the second water-repellent-layer-free region 12 of the upper side substrate 21, and then bonding the lower side substrate 20 to the upper side substrate 21. In a case where the lower side substrate 20 is bonded to the upper side substrate 21, it is possible to bond the substrates together with high sealing strength without carrying out strict alignment.

[Recap]

The electrowetting device (100) in accordance with an aspect 1 of the present disclosure includes: an active substrate (14) including a first substrate (1), a first electrode layer (2) provided on the first substrate, a dielectric layer (3) provided so as to cover the first electrode layer, and a first water-repellent layer (4) which has surface tension smaller than that of the dielectric layer and is provided on the dielectric layer; and a common electrode substrate (15) including a second substrate (8), a second electrode layer (7) provided on the second substrate, and a second water-repellent layer (6) which has surface tension smaller than that of the second electrode layer and is provided on the second electrode layer, the active substrate and the common electrode substrate being bonded together with a sealing material (5) such that a space is formed between the active substrate and the common electrode substrate and the first water-repellent layer and the second water-repellent layer face each other, the sealing material being provided in sealing regions, at least one of the dielectric layer and the second electrode layer having thereon a water-repellent layer formation region in which the water-repellent layer is provided and (ii) a water-repellent-layer-free region, the sealing regions being provided so as to at least partially overlap with the water-repellent-layer-free region in a plan view, and the space having a size of 10 μm to 500 μm.

According to the configuration, it is possible to obtain, without precise alignment, firm adhesion between each of the substrates and the sealing material in the part in which the water-repellent-layer-free region and the sealing region overlap with each other.

According to the electrowetting device in accordance with an aspect 2 of the present disclosure, it is preferable in the aspect 1 that the water-repellent-layer-free region is an opening region in the water-repellent layer.

According to the configuration, it is possible to maintain a better adhesive property between each of the substrates and the sealing material.

According to the electrowetting device in accordance with an aspect of the present disclosure, it is preferable in the aspect 1 that the water-repellent-layer-free region is a part of the water-repellent layer which part has been subjected to surface modification by local surface treatment.

According to the configuration, it is possible to secure a good adhesive property even in the water-repellent-layer-free region which has been formed by simple surface treatment method.

According o the electrowetting device in accordance with an aspect 4 of the present disclosure, it is preferable in the aspect 1 that the dielectric layer has a first water-repellent-layer-free region thereon and the second electrode layer has a second water-repellent-layer-free region thereon, each of the first water-repellent-layer-free region and the second water-repellent-layer-free region being the water-repellent-layer-free region; and one of the first water-repellent-layer-free region and the second water-repellent-layer-free region is a part of the water-repellent layer which part has been subjected to surface modification by local surface treatment, and the other of the first water-repellent-layer-free region and the second water-repellent-layer-free region is an opening region in the water-repellent layer.

According to the configuration, various arrangements may be employed depending on intended adhesive property and positional precision.

According to the electrowetting device in accordance with an aspect 5 of the present disclosure, it is preferable in any of the aspects 1 through 4 that the sealing region is provided in a whole circumference part on each of facing surfaces of the active substrate and the common electrode substrate which are bonded together; the water-repellent-layer-free region is provided in the whole circumference part on at least one of the facing surfaces of the active substrate and the common electrode substrate; an edge of the sealing region on a substrate inner side is located on an outer side than an edge of the water-repellent-layer-free region on the substrate inner side; and a shortest distance a between the edge of the sealing region on the substrate inner side and the edge of the water-repellent-layer-free region on the substrate inner side is 150 μm or less in the whole circumference part of the at least one of the facing surfaces.

According to the configuration, it is possible to maintain a good adhesive property between each of the substrates and the sealing material, and it is possible to maximally secure the region for manipulating a droplet in the cell.

According to the electrowetting device in accordance with an aspect 6 of the present disclosure, it is preferable in any of the aspects 1 through 5 that the sealing material is provided with at least one opening.

According to the configuration, it is possible to laterally feed a reagent into the electrowetting device.

The method in accordance with an aspect 7 of the present disclosure for producing an electrowetting device includes: an active substrate forming step including forming a first electrode layer on a first substrate, forming a dielectric layer which covers the first electrode layer, and forming a first water-repellent layer on the dielectric layer, the first water-repellent layer having surface tension smaller than that of the dielectric layer; a common electrode substrate forming step including forming a second electrode layer on a second substrate, and forming a second water-repellent layer on the second electrode layer, the second water-repellent layer having surface tension smaller than that of the second electrode layer; a bonding step of bonding the active substrate and the common electrode substrate together with a sealing material such that a space is formed between the active substrate and the common electrode substrate and the first water-repellent layer and the second water-repellent layer face each other, the sealing material being provided in sealing regions; and a water-repellent-layer-free region forming step of forming a water-repellent-layer-free region, in which the water-repellent layer is not provided, on at least one of the dielectric layer and the second electrode layer, in the bonding step, the sealing regions being formed so as to at least partially overlap with the water-repellent-layer-free region in a plan view, and the active substrate and the common electrode substrate being bonded together such that the space has a size of 10 μm to 500 μm.

According to the configuration, the electrowetting device in which the sealing material firmly adheres to each of the substrates can be produced at a high yield.

According to the production method in accordance with an aspect 8 of the present disclosure, it is possible in the aspect 7 that the water-repellent-layer-free region forming step includes a first step of forming a resist film (17) in a predetermined pattern a second step of forming the water-repellent layer so that the water-repellent layer covers the resist film, and a third step of removing the resist film and also a part of the water-repellent layer which part is provided on the resist film.

According to the method, it is possible to provide the method for producing the electrowetting device in which the water-repellent-layer-free region is formed with use of the removing step.

According to the production method in accordance with an aspect 9 of the present disclosure, it is possible in the aspect 7 that the water-repellent-layer-free region forming step includes a first step of forming the water-repellent layer, a second step of forming a resist film (dry etching mask 18) on the water-repellent layer in a predetermined pattern, a third step of forming a water-repellent-layer-free region by removing a part of the water-repellent layer by carrying out dry etching while using the resist film as a mask, and a forth step of removing the resist film on the water-repellent layer.

According to the method, it is possible to provide the method for producing the electrowetting device in which the water-repellent-layer-free region is formed by carrying out dry etching.

[Additional Remarks]

The present disclosure is not limited to the embodiments, but can be altered by a skilled person in the art within the scope of the claims. The present disclosure also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1: First substrate

2: First electrode layer

3: Dielectric layer

4: First water-repellent layer

5: Sealing material

6: Second water-repellent layer

7: Second electrode layer

8: Second substrate

9: Thin film transistor formation layer

11: First water-repellent-layer-free region

12: Second water-repellent-layer-free region

14: Active substrate

15: Common electrode substrate

17: Resist

18: Dry etching mask

20: Lower side substrate

21: Upper side substrate

22: Droplet

100, 100V: Electrowetting device

1. An electrowetting device comprising:
an active substrate including a first substrate, a first electrode layer provided on the first substrate, a dielectric layer provided so as to cover the first electrode layer, and a first water-repellent layer which has surface tension smaller than that of the dielectric layer and is provided on the dielectric layer; and
a common electrode substrate including a second substrate, a second electrode layer provided on the second substrate, and a second water-repellent layer which has surface tension smaller than that of the second electrode layer and is provided on the second electrode layer,
the active substrate and the common electrode substrate being bonded together with a sealing material such that a space is formed between the active substrate and the common electrode substrate and the first water-repellent layer and the second water-repellent layer face each other, the sealing material being provided in sealing regions,
at least one of the dielectric layer and the second electrode layer having thereon (i) a water-repellent layer formation region in which the water-repellent layer is provided and a water-repellent-layer-free region,
the sealing regions being provided so as to at least partially overlap with the water-repellent-layer-free region in a plan view, and
the space having a size of 10 μm to 500 μm.

2. The electrowetting device as set forth in claim 1, wherein the water-repellent-layer-free region is an opening region in the water-repellent layer.

3. The electrowetting device as set forth in claim 1, wherein the water-repellent-layer-free region is a part of the water-repellent layer which part has been subjected to surface modification by local surface treatment.

4. The electrowetting device as set forth in claim 1, wherein:
the dielectric layer has a first water-repellent layer-free region thereon and the second electrode layer has a second water-repellent-layer-free region thereon, each of the first water-repellent-layer-free region and the second water-repellent-layer-free region being said water-repellent-layer-free region; and
one of the first water-repellent-layer-free region and the second water-repellent-layer-free region is a part of the water-repellent layer which part has been subjected to surface modification by local surface treatment, and the other of the first water-repellent-layer-free region and the second water-repellent-layer-free region is an opening region in the water-repellent layer.

5. The electrowetting device as set forth in claim 1, wherein:
the sealing region is provided in a whole circumference part on each of facing surfaces of the active substrate and the common electrode substrate which are bonded together;
the water-repellent-layer-free region is provided in the whole circumference part on at least one of the facing surfaces of the active substrate and the common electrode substrate;
an edge of the sealing region on a substrate inner side is located on an outer side than an edge of the water-repellent-layer-free region on the substrate inner side; and
a shortest distance a between the edge of the sealing region on the substrate inner side and the edge of the water-repellent-layer-free region on the substrate inner side is 150 μm or less in the whole circumference part of the at least one of the facing surfaces.

6. The electrowetting device as set forth in claim 1 wherein the sealing material is provided with at least one opening.

7. A method for producing an electrowetting device, said method comprising:
an active substrate forming step including forming a first electrode layer on a first substrate, forming a dielectric layer which covers the first electrode layer, and forming a first water-repellent layer on the dielectric layer, the first water-repellent layer having surface tension smaller than that of the dielectric layer;
a common electrode substrate forming step including forming a second electrode layer on a second substrate, and forming a second water-repellent layer on the second electrode layer, the second water-repellent layer having surface tension smaller than that of the second electrode layer;
a bonding step of bonding the active substrate and the common electrode substrate together with a sealing material such that a space is formed between the active substrate and the common electrode substrate and the first water-repellent layer and the second water-repellent layer face each other, the sealing material being provided in sealing regions; and
a water-repellent-layer-free region forming step of forming a water-repellent-layer-free region, in which the water-repellent layer is not provided, on at least one of the dielectric layer and the second electrode layer,
in the bonding step, the sealing regions being formed so as to at least partially overlap with the water-repellent-layer-free region in a plan view, and the active substrate and the common electrode substrate being bonded together such that the space has a size of 10 μm to 500 μm.

8. The method as set forth in claim 7, wherein:
the water-repellent-layer-free region forming step includes a first step of forming a resist film in a predetermined pattern, a second step of forming the water-repellent layer so that the water-repellent layer covers the resist film, and a third step of removing the resist film and also a part of the water-repellent layer which part is provided on the resist film.

9. The method as set forth in claim 7, wherein:
the water-repellent-layer-free region forming step includes a first step of forming the water-repellent layer, a second step of forming a resist film on the water-repellent layer in a predetermined pattern, a third step of forming a water-repellent-layer-free region by removing a part of the water-repellent layer by carrying out dry etching while using the resist film as a mask, and a forth step of removing the resist film on the water-repellent layer.
